(19) United States
(12) Patent Application Publication
(10) Pub. No.: US 2016/0059151 A1
(43) Pub. Date: Mar. 3, 2016

(54) ULTRATHIN LAYER CHROMATOGRAPHY PLATES COMPRISING ELECTROSPUN NANOFIBERS

(71) Applicant: OHIO STATE INNOVATION FOUNDATION, Columbus, OH (US)

(72) Inventors: Susan V. OLESIK, Dublin, OH (US); Xin FANG, Columbus, OH (US)

(21) Appl. No.: 14/778,941

(22) PCT Filed: Mar. 21, 2014
(86) PCT No.: PCT/US14/31476

§ 371 Date: Sep. 21, 2015

Related U.S. Application Data
(60) Provisional application No. 61/803,975, filed on Mar. 21, 2013.

(51) Int. Cl. B01D 15/32; B29C 47/00; G01N 30/92

(52) U.S. Cl. CPC B01D 15/327; G01N 30/92; B29C 47/0004; B82Y 40/00

(57) ABSTRACT

An ultrathin-layer chromatography plate comprising a stationary phase including electrospun composite nanofibers comprising a polymer and at least one of multi-walled carbon nanotubes, edge-plane ordered carbon nanorods and amorphous carbon nanorods, wherein the stationary phase has a thickness between about 5 μm and about 30 μm.

### CROSS-REFERENCE TO RELATED APPLICATIONS

This application claims priority to U.S. Provisional Patent Application No. 61/803,975, filed Mar. 21, 2013, which is incorporated herein in its entirety by reference.

### STATEMENT REGARDING FEDERALLY-SPONSORED RESEARCH

The present invention was made with Government support under Grant No. GRT00018647 awarded by the U.S. National Science Foundation. The United States Government may have certain rights to this invention under 35 U.S.C §200 et seq.

### BACKGROUND

Thin layer chromatography (TLC) is a type of liquid chromatography in which the stationary phase is a thin layer of sorbent attached on a flat surface rather than packed into a column. The history of TLC dates back to drop chromatography developed in late 1930s, when Izmailov and Schraiber separated medical compounds by applying drops of solvent to glass plates containing sorbents layer and sample spots. Due to large contributions from Kirchner and Stahl, modern TLC was established in the 1950s, and continues to be widely used today in synthetic chemistry, environmental analysis, food and pharmaceutical industries. In the 1970s, high performance thin layer chromatography (HPTLC) came about as a result of combinational improvements in several aspects of conventional TLC. These improvements include higher quality of sorbents, optimized techniques of sample application, novel methods for solvent development as well as improved plate manufacturing consistency. Ultrathin layer chromatography (UTLC) was introduced in 2001 to further improve separation efficiency and reduce analysis time and solvent consumption. Compared with typical layer thickness (100-400 μm) for classic TLC, UTLC plates made with monolithic silica gel have a sorbent layer ˜10 μm thick. Most recently, a 4.6-5.3 μm thick normal phase silica UTLC device with varied macropore architecture was created using glancing angle deposition method, and demonstrated theoretical plate height as small as 12-28 μm.

A great amount of sorbent materials for TLC have been reported, including silica gel, cellulose, alumina, polyamides and ion exchange resins. The large variety of available stationary phases offers considerable choices for highly efficient analyses of all types of compounds. Recently, it was demonstrated that nanofibers generated by electrospinning have great potential to be utilized as a stationary phase for UTLC. Compared with commercially available cyano phase TLC plates, electrospun polyacrylonitrile (PAN) UTLC plates were reported not only to reduce analysis time and solvent consumption, but also to substantially increase the separation efficiency. It also has been reported that an electrospun glassy carbon stationary phase for UTLC had plate number values over 10,000, and showed tunable retention and robustness for a wide range of mobile phases.

Electrospinning is a simple and versatile method to produce polymer nanofibers. The technique involves the application of a high electric potential to charge the surface of a polymer solution droplet and induce the ejection of a polymeric jet. The polymeric jet is further elongated by a whipping process and is finally deposited on a grounded collector. A number of experimental parameters including electric potential, flow rate and distance between syringe and collector, control the fiber diameter and morphology. The nanofibers can be fabricated into various forms such as porous fibers, beads, ribbons, helices and patterned mats. The electrospun nanofibers have been successfully applied in areas of air filtration, fabric manufacture, optical sensors and drug delivery.

Carbon materials have been widely used as stationary phase in separation science due to their unique selectivity and stability. The wide variety of potential intermolecular interactions that can occur between carbon surfaces and target analytes makes carbon stationary phases applicable to a wide variety of separation applications. Among these carbon materials, carbon nanotubes (CNTs) have received great attention due to their unique chemical, mechanical and electrical properties. CNTs are formed by rolling up layers of graphene sheets into seamless cylinders with nanoscale diameter. CNTs are categorized as single-walled nanotubes (SWNTs) with a single graphite layer and multi-walled nanotubes (MWNTs) consisting of multiple layers of graphite forming into concentric tubes. CNTs are attractive sorbents, because they have a high aspect ratio and a large surface area ranging from 150-3000 m²/g. The adsorption can occur on the surface of the outside wall, in the interstitial space between tube bundles, and on the inside when they are open-ended. Due to their high adsorption capacity, CNTs have been widely involved in many analytical techniques such as gas sensor, voltammetry, solid phase extraction and chromatography. The nonporous structure leading to fast mass transport, along with high thermal stability makes CNTs excellent as gas chromatography stationary phase. Recent studies showed that CNTs used as gas chromatography stationary phases were able to separate a wide range of compounds ranging from small gas molecules to relatively large polycyclic aromatics. CNTs have also been used as stationary phase in liquid chromatography and capillary electrochromatography. A study reported that SWNTs were incorporated into an organic polymer containing vinylbenzyl chloride and ethylene dimethacrylate to form a monolithic stationary phase. The strong hydrophobicity of SWNTs resulted in improved chromatograghic retention of small neutral molecules in the reversed phase mode. In spite of these numerous applications in column chromatography, CNTs used in a TLC stationary phase has never been reported.

Although carbon materials as stationary phases demonstrate unique sorption behavior to a wide variety of analytes, the chromatographic efficiency of carbon surfaces is limited by the fact that they are composed of at least two different surface active sites for interaction: edge plane and basal plane carbon sites. FIG. 1 illustrates one proposed model of the heterogeneous structure of glassy carbon. It has been theorized that each surface site may interact with solutes differently. For instance, basal plane sites, the flat surfaces, may interact more strongly with analytes via charge-induced and dispersion interactions than the edge plane sites, which are located on the end of the grapheme ribbons. It is believed that the edge plane sites may be populated by valency satisfying groups, such as amino, carbonyl, carboxylic, or hydroxyl groups. Clearly, it would be advantageous to employ carbon stationary phases where the surface sites were comprised solely of either edge plane or basal plane surfaces. Increasing the surface homogeneity of carbon stationary phases may not only increase the chromatographic efficiency of the separation by reducing the available range of interaction energies present within the stationary phase but may also allow for more selective separations.

Ordered carbon nanomaterials, in which the surface consists of either all edge plane or basal plane sites, have been generated for a number of years. One way in which ordered carbon nanomaterials can be prepared is via specific treatment of discotic liquid crystal mesophase. Discotic liquid crystal mesophase is formed by graphitizable carbons during heat treatment; it is believed that the discs are composed of condensed polynuclear aromatic compounds. Discotic liquid crystals (DLC) have been shown to achieve characteristic alignment at phase boundaries or surfaces. FIG. 2 shows the two possible anchoring states, edge-on or face-on, for DLC at a surface. The anchoring state of the DLC is governed primarily by the characteristics of the surface to which the DLC is anchoring. Strong π-π interactions exist between the discs of the DLC; if the inter-disc π-π interactions are stronger than the interaction between the discs and the anchoring surface, the DLC will anchor to the surface in an edge-on fashion. If the interactions between the surface and the discs are stronger than the π-π interactions between the discs, face-on anchoring occurs. The roughness of the surface also contributes to the anchoring state of the DLC. Rough surfaces are more likely to generate edge-on anchoring states while smooth substrates favor face-on anchoring. Oxidized surfaces, such as Al₂O₃ and SiO₂, facilitate edge-on anchoring by the DLC whereas oxidation-resistant metals such as silver and platinum, cause face-on anchoring. Once surface anchoring of the DLC has been achieved, pyrolysis can be performed to generate ordered carbon nanomaterials, which are subsequently removed from the anchoring substrate.

### SUMMARY

This disclosure provides ultrathin-layer chromatography plates comprising a stationary phase including electrospun composite nanofibers comprising a polymer and at least one of multi-walled carbon nanotubes (MWNTs), edge-plane ordered carbon nanorods (EPC nanorods) and amorphous carbon nanorods (AC nanorods), wherein the stationary phase has a thickness between about 5 μm and about 30 μm. These ultrathin-layer chromatography plates are useful for separating a wide variety of compounds, including, but not limited to, laser dyes, polycyclic aromatic hydrocarbons (PAHs) and analgesic drugs.

This disclosure also provides methods of making ultrathin-layer chromatography plates having a stationary phase comprising composite nanofibers comprising a polymer and at least one of MWNTs, EPC nanorods and AC nanorods, the method comprising electrospinning a solution comprising the polymer and at least one of multi-walled carbon nanotubes, edge-plane ordered carbon nanorods and amorphous carbon nanorods to form a mat comprising the composite nanofibers.

### BRIEF DESCRIPTION OF THE DRAWINGS

FIG. 1 is an illustration of graphene layer structure of amorphous glassy carbon.

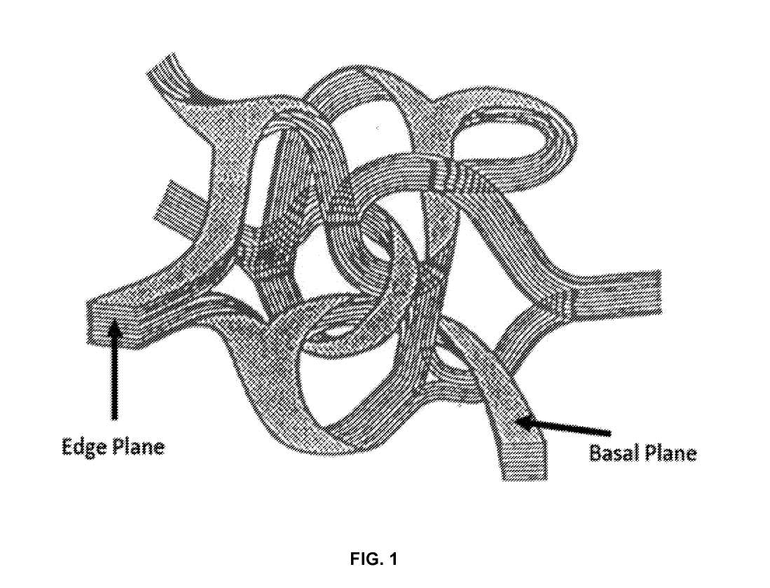

FIG. 2 is an illustration of edge-on (left) and face-on (right) anchoring states of DLC on a substrate. The arrows indicate the direction normal to the substrate.^{26,29}

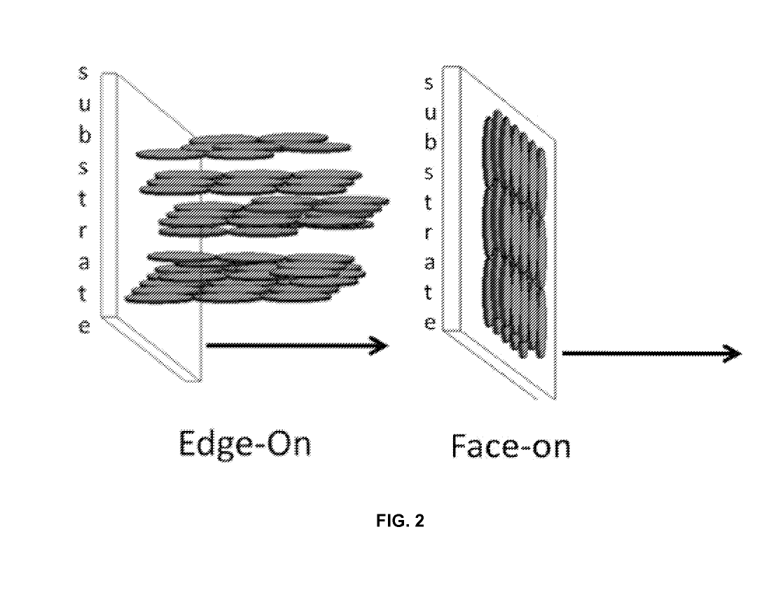

FIG. 3 is an illustration showing a synthetic pathway for the generation of carbon nanorods.

FIG. 4 is a pair of SEM images of 0.5% MWNT-PAN composite electrospun nanofibers.

FIG. 5 is shows the Raman spectra of 0.5% MWNT-PAN composite fibers and of pure PAN fibers.

FIG. 6 is an SEM image of EPC nanorods prepared by template-directed liquid crystal synthesis.

FIG. 7 shows (a) a TEM image of an EPC nanorod, and (b) a TEM image of an AC nanorod.

FIG. 8 is an SEM image of 0.5% EPC-PAN electrospun composite nanofibers.

FIG. 9 is a series of bar charts showing the distributions of fiber diameters for (Top) pure PAN fibers, (Middle) 0.25% EPC-PAN fibers, and (Bottom) 0.5% EPC-PAN fibers.

FIG. 10 is a chart showing the retention factors (R_{f}) of (♦) kiton red, (▪) sulforodamine 640, (▴) rhodamine 610 chloride, () rhodamine 590 on MWNT-PAN plates, EPC-PAN plates, AC-PAN plates and pure PAN plates using 2-propanol/methanol 80:20 (v/v) as the mobile phase.

FIG. 11 is a chart showing the retention factors (R_{f}) of (♦) phenanthrene, (▴) pyrene, (▪) chrysene, and () benzo-(a)pyrene on 0.5% MWNT-PAN plates using varying concentrations of acetonitrile in H₂O as the mobile phase.

FIG. 12 is a chart showing the retention factors (R_{f}) of (♦) phenanthrene, (▴) pyrene, (▪) chrysene, and () benzo-(a)pyrene on 0.5% EPC-PAN plates using varying concentrations of acetonitrile in H₂O as the mobile phase.

FIG. 13 is a chart showing the retention factors (R_{f}) of (♦) phenanthrene, (▴) pyrene, (▪) chrysene, and () benzo-(a)pyrene on 0.5% AC-PAN plates using varying concentrations of acetonitrile in H₂O as the mobile phase.

FIG. 14 is a chart showing the retention factors (R_{f}) of (♦) phenanthrene, (▴) pyrene, (▪) chrysene, and () benzo-(a)pyrene on pure PAN plates using varying concentrations of acetonitrile in H₂O as the mobile phase.

FIG. 15 is a bar chart comparing the separation efficiency on carbon nanoparticle-PAN plates and pure PAN plate for the separation of phenanthrene, pyrene, chrysene and benzo-(a)pyrene.

FIG. 16 is a bar chart comparing resolution on carbon nanoparticle-PAN plates and pure PAN plate for the separation of various combinations of compounds.

FIG. 17 is a chart showing the retention factors (R_{f}) of (♦) salicylic acid, (▪) acetanilide, (▴) phenacetin on 0.5% EPC-PAN plates using varying concentrations of CH₂Cl₂ in hexane as the mobile phase.

FIG. 18 is a chart showing the retention factors (R_{f}) of (♦) salicylic acid, (▪) acetanilide, (▴) phenacetin on 0.5% AC-PAN plates using varying concentrations of CH₂Cl₂ in hexane as the mobile phase.

FIG. 19 is a chart showing the retention factors (R_{f}) of (♦) salicylic acid, (▪) acetanilide, (▴) phenacetin on pure PAN plates using varying concentrations of CH₂Cl₂ in hexane as the mobile phase.

FIG. 20 is a bar chart comparing the separation efficiency of EPC-PAN plates, AC-PAN plates and pure PAN plates for the separation of salicylic acid, acetanilide and phenacetin.

### DETAILED DESCRIPTION

This disclosure is not limited in its application to the details of construction and the arrangement of components set forth in the following description. The disclosure may provide other embodiments and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

It should be understood that, as used herein, the term “about” is synonymous with the term “approximately.” Illustratively, the use of the term “about” indicates that a value includes values slightly outside the cited values. Variation may be due to conditions such as experimental error, manufacturing tolerances, variations in equilibrium conditions, and the like. In some embodiments, the term “about” includes the cited value plus or minus 10%. In all cases, where the term “about” has been used to describe a value, it should be appreciated that this disclosure also supports the exact value.

This disclosure provides ultrathin-layer chromatography plates and methods of making and using ultrathin-layer chromatography plates, as described in detail below.

### I. Ultrathin-Layer Chromatography Plates

This disclosure provides ultrathin-layer chromatography plates including a stationary phase comprising electrospun nanofibers, wherein the stationary phase has a thickness from about 5 μm to about 30 μm.

The UTLC plates disclosed herein may comprise a stationary phase having a thickness of at least about 5 μm, such as at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 21 μm, at least about 22 μm, at least about 23 μm, at least about 24 μm, at least about 25 μm, at least about 26 μm, at least about 27 μm, at least about 28 μm, or at least about 29 μm. The UTLC plates disclosed herein may comprise a stationary phase having a thickness of at most about 30 μm, such as at most about 29 μm, at most about 28 μm, at most about 27 μm, at most about 26 μm, at most about 25 μm, at most about 24 μm, at most about 23 μm, at most about 22 μm, at most about 21 μm, at most about 20 μm, at most about 19 μm, at most about 18 μm, at most about 17 μm, at most about 16 μm, at most about 15 μm, at most about 14 μm, at most about 13 μm, at most about 12 μm, at most about 11 μm, at most about 10 μm, at most about 9 μm, at most about 8 μm, at most about 7 μm, or at most about 6 μm. This includes embodiments where the stationary phase thickness ranges from about 50 μm to about 30 μm, including, but not limited to, ranges from about 7.5 μm to about 27.5 μm, and from about 10 μm to about 25 μm.

The UTLC plate disclosed herein may comprise a stationary phase having a length and a width. In some embodiments, the UTLC plate may comprise a stationary phase having a thickness that is substantially consistent along its entire length and width.

Electrospun Nanofibers

The UTLC plates disclosed herein may comprise a stationary phase including electrospun nanofibers comprising a polymer and at least one of MWNTs, EPC nanorods and AC nanorods.

The electrospun comprise nanofibers may comprise between 0% and about 5% by weight of any of the MWNTs, AC nanorods, or EPC nanorods. For example, the electrospun nanofibers may comprise at least about 0.1 wt % MWNTs, AC nanorods or EPC nanorods, such as at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1.0 wt %, at least about 1.5 wt %, at least about 2.0 wt %, at least about 2.5 wt %, at least about 3.0 wt %, at least about 3.5 wt %, at least about 4.0 wt %, or at least about 4.5 wt % MWNTs, AC nanorods or EPC nanorods. The electrospun nanofibers may comprise at most about 5.0 wt % carbon MWNTs, AC nanorods or EPC nanorods, such as at most about 4.5 wt %, at most about 4.0 wt %, at most about 3.5 wt %, at most about 3.0 wt %, at most about 2.5 wt %, at most about 2.0 wt %, at most about 1.5 wt %, at most about 1.0 wt %, at most about 0.9 wt %, at most about 0.8 wt %, at most about 0.7 wt %, at most about 0.6 wt %, at most about 0.5 wt %, at most about 0.4 wt %, or at most about 0.3 wt % carbon MWNTs, AC nanorods or EPC nanorods. This includes, but is not limited to, embodiments wherein the electrospun nanofibers comprise between about 0.5 wt % and about 4.5 wt %, between about 0.5 wt % and about 4.0 wt %, between about 0.5 wt % and about 3.0 wt %, between about 0.5 wt % and about 2.5 wt %, between about 0.5 wt % and about 2.0 wt %, between about 1.0 wt % and about 4.5 wt %, between about 1.0 wt % and about 4.0 wt %, between about 1.0 wt % and about 3.5 wt %, between about 1.0 wt % and about 3.0 wt %, between about 1.0 wt % and about 2.5 wt %, between about 1.0 wt % and about 2.0 wt %, between about 0.5 wt % and about 3.5 wt %, between about 0.5 wt % and about 3.5 wt %, between about 0.5 wt % and about 3.5 wt %,between about and between about 0.10 wt % and about 0.40 wt % MWNTs, AC nanorods or EPC nanorods.

In some embodiments of composite nanofibers comprising MWNTs, the MWNTs may be treated with acid to form carboxylic acid functional groups on the surface of the MWNTs.

Composite nanofibers comprising MWNTs, AC nanorods and/or EPC nanorods may have average diameters between about 200 nm and about 600 nm. For example, composite nanofibers comprising MWNTs may have an average diameter of at least about 210 nm, such as at least about 220 nm, at least about 230 nm, at least about 240 nm, at least about 250 nm, at least about 260 nm, at least about 270 nm, at least about 280 nm, at least about 290 nm, at least about 300 nm, at least about 310 nm, at least about 320 nm, at least about 330 nm, at least about 340 nm, at least about 350 nm, at least about 360 nm, at least about 370 nm, at least about 380 nm, at least about 390 nm, at least about 400 nm, at least about 410 nm, at least about 420 nm, at least about 430 nm, at least about 440 nm, at least about 450 nm, at least about 460 nm, at least about 470 nm, at least about 480 nm, at least about 490 nm, at least about 500 nm, at least about 510 nm, at least about 520 nm, at least about 530 nm, at least about 540 nm, at least about 550 nm, at least about 560 nm, at least about 570 nm, at least about 580 nm, or at least about 590 nm. Composite nanofibers comprising MWNTs may have an average diameter of at most about 600 nm, such as at most about 590 nm, at most about 580 nm, at most about 570 nm, at most about 560 nm, at most about 550 nm, at most about 540 nm, at most about 530 nm, at most about 520 nm, at most about 510 nm, at most about 500 nm, at most about 490 nm, at most about 480 nm, at most about 470 nm, at most about 460 nm, at most about 450 nm, at most about 440 nm, at most about 430 nm, at most about 420 nm, at most about 410 nm, at most about 400 nm, at most about 390 nm, at most about 380 nm, at most about 370 nm, at most about 360 nm, at most about 350 nm, at most about 340 nm, at most about 330 nm, at most about 320 nm, at most about 310 nm, at most about 300 nm, at most about 290 nm, at most about 280 nm, at most about 270 nm, at most about 260 nm, at most about 250 nm, at most about 240 nm, at most about 230 nm, at most about 220 nm, or at most about 210 nm. This includes, but is not limited to, embodiments where the electrospun composite nanofibers have an average diameter ranging from about 275 nm to about 500 nm, and from about 300 nm to about 400 nm.

The electrospun nanofibers may comprise a polymer selected from, but not limited to, a polyacrylonitrile, an epoxide polymer, a polycaprolactone, a polystyrene, a polyvinyl alcohol, a poly(methyl methacrylate), a polyhydroxyalkanoate, and a polyethylene. In some embodiments, the polymer may be a polyacrylonitrile.

### II. Methods of Making Ultrathin-Layer Chromatography Plates

This disclosure provides methods of making UTLC plates having a stationary phase comprising composite nanofibers comprising a polymer and at least one of MWNTs, EPC nanorods and AC nanorods. The method may comprise electrospinning a solution comprising the polymer and at least one of the MWNTs, EPC nanorods and AC nanorods to form a mat comprising the composite nanofibers. In some embodiments, the method further may comprise heat treating the mat to form the stationary phase.

Electrospinning Target

In principle, the electrospinning target can be any target suitable for receiving the electrospun nanofibers of this disclosure. In principle, the electrospinning target may comprise any electrically conductive material or combination thereof.

In some embodiments, the electrospinning target may be of any suitable shape and size. In preferred embodiments, the electrospinning target may be substantially rectangular in shape.

In some embodiments, the electrospinning target may comprise a material selected from the group consisting of aluminum, steel, silicon, conductive glass plate, and combinations thereof.

Electrospinning Fibers

As used herein, the term electrospinning refers generally to placing a high electric field between a polymer or polymer-composite solution and a conductive collector. This collector may be comprised of many different materials such as metals, conductive polymers or the like, and may take the form of a plate, a film, a filament, a rod etc. When an electric field strong enough to overcome the surface tension of the droplet is provided, a Taylor cone is formed. Following the creation of the Taylor cone, fibers are ejected toward the conductive collector. With this technique, many different polymers and polymer blends can be used to generate and spin fibers with various chemical compositions and to fabricate mats comprising the fibers without the aid of binders.

In some embodiments, the methods may comprise electrospinning a solution comprising a polymer (e.g., a polyacrylonitrile, an epoxide polymer, a polycaprolactone, a polystyrene, a polyvinyl alcohol, a poly(methyl methacrylate), a polyhydroxyalkanoate, and a polyethylene, among others) and at least one of MWNTs, EPC nanorods and AC nanorods to form a mat comprising MWNT-polymer, EPC-polymer and/or AC-polymer composite nanofibers. For example, in some embodiments, the methods may comprise electrospinning a solution comprising a polyacrylonitrile (PAN) and at least one of MWNTs, EPC nanorods and AC nanorods to form a mat comprising MWNT-PAN, EPC-PAN or AC-PAN composite nanofibers.

In some embodiments, the electrospinning step may be performed at an applied voltage of at least about 1 kV, such as at least about 2 kV, at least about 3 kV, at least about 4 kV, at least about 5 kV, at least about 6 kV, at least about 7 kV, at least about 8 kV, at least about 9 kV, at least about 10 kV, at least about 11 kV, at least about 12 kV, at least about 13 kV, at least about 14 kV, at least about 15 kV, at least about 16 kV, at least about 17 kV, at least about 18 kV, at least about 19 kV, at least about 20 kV, at least about 21 kV, at least about 22 kV, at least about 23 kV, at least about 24 kV, at least about 25 kV, at least about 26 kV, at least about 27 kV, at least about 28 kV, at least about 29 kV, at least about 30 kV, or at least about 40 kV. In some embodiments, the electrospinning step may be performed at an applied voltage of at most about 50 kV, such as at most about 40 kV, at most about 35 kV, at most about 30 kV, at most about 29 kV, at most about 28 kV, at most about 27 kV, at most about 26 kV, at most about 25 kV, at most about 24 kV, at most about 23 kV, at most about 22 kV, at most about 21 kV, at most about 20 kV, at most about 19 kV, at most about 18 kV, at most about 17 kV, at most about 16 kV, at most about 15 kV, at most about 14 kV, at most about 13 kV, at most about 12 kV, at most about 11 kV, at most about 10kV, or at most about 5 kV. This includes embodiments wherein the electrospinning step is performed at applied voltages ranging from about 1 kV to about 50 kV, including, but not limited to applied voltages ranging from 10 kV to about 30 kV, and from about 15 kV to about 25 kV.

In some embodiments, the electrospinning step may be performed at a flow rate of at least about 1 μL/min, such as at least about 5 μL/min, at least about 10 μL/min, at least about 11 μL/min, at least about 12 μL/min, at least about 13 μL/min, at least about 14 μL/min, at least about 15 μL/min, at least about 16 μL/min, at least about 17 μL/min, at least about 18 μL/min, at least about 19 μL/min, at least about 20 μL/min, at least about 21 μL/min, at least about 22 μL/min, at least about 23 μL/min, at least about 24 μL/min, at least about 25 μL/min, at least about 26 μL/min, at least about 27 μL/min, at least about 28 μL/min, at least about 29 μL/min, at least about 30 μL/min, at least about 35 μL/min, at least about 40 μL/min, at least about 45 μL/min, at least about 50 μL/min, at least about 60 μL/min, at least about 70 μL/min, at least about 80 μL/min, or at least about 90 μL/min. In some embodiments, the electrospinning step may be performed at a flow rate of at most about 100 μL/min, such as at most about 90 μL/min, at most about 80 μL/min, at most about 75 μL/min, at most about 70 μL/min, at most about 65 μL/min, at most about 60 μL/min, at most about 55 μL/min, at most about 50 μL/min, at most about 45 μL/min, at most about 40 μL/min, at most about 35 μL/min, at most about 30 μL/min, at most about 29 μL/min, at most about 28 μL/min, at most about 27 μL/min, at most about 26 μL/min, at most about 25 μL/min, at most about 24 μL/min, at most about 23 μL/min, at most about 22 μL/min, at most about 21 μL/min, at most about 20 μL/min, at most about 19 μL/min, at most about 18 μL/min, at most about 17 μL/min, at most about 16 μL/min, at most about 15 μL/min, at most about 14 μL/min, at most about 13 μL/min, at most about 12 μL/min, at most about 11 μL/min, at most about 10 μL/min, at most about 5 μL/min, or at most about 2 μL/min. This include embodiments wherein the electrospinning step is performed at flow rates ranging from about 1 μL/min to about 100 μL/min, including, but not limited to, flow rates ranging from about 5 μL/min to about 50 μL/min, and from about 10 μL/min to about 30 μL/min.

In some embodiments, the electrospinning step may be performed with a distance from the electrospinning tip to target of at least about 1 cm, such as at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, at least about 19 cm, at least about 20 cm, at least about 21 cm, at least about 22 cm, at least about 23 cm, at least about 24 cm, at least about 25 cm, at least about 26 cm, at least about 27 cm, at least about 28 cm, at least about 29 cm, at least about 30 cm, at least about 35 cm, at least about 40 cm, or at least about 45 cm. In some embodiments, the electrospinning step may be performed with a distance from the electrospinning tip to target of at most about 50 cm, such as at most about 45 cm, at most about 40 cm, at most about 35 cm, at most about 34 cm, at most about 33 cm, at most about 32 cm, at most about 31 cm, at most about 30 cm, at most about 29 cm, at most about 28 cm, at most about 27 cm, at most about 26 cm, at most about 25 cm, at most about 24 cm, at most about 23 cm, at most about 22 cm, at most about 21 cm, at most about 20 cm, at most about 19 cm, at most about 18 cm, at most about 17 cm, at most about 16 cm, at most about 15 cm, at most about 14 cm, at most about 13 cm, at most about 12 cm, at most about 11 cm, at most about 10 cm, at most about 5 cm, or at most about 2 cm. This includes embodiments wherein the electrospinning step is performed with a distance from the electrospinning tip to target ranging from about 1 cm to about 50 cm, including, but not limited to, distances ranging from about 5 cm to about 30 cm, and distances ranging from about 10 cm to about 20 cm.

In some embodiments, the electrospinning step may be performed for a length of time at least about 5 minutes, such as at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, at least about 1 hour, at least about 2 hours, at least about 3 hours, at least about 4 hours, at least about 8 hours, or at least about 12 hours. In some embodiments, the electrospinning step may be performed for a length of time at most about 24 hours, such as at most about 12 hours, at most about 8 hours, at most about 7 hours, at most about 6 hours, at most about 5 hours, at most about 4 hours, at most about 3 hours, at most about 2 hours, at most about 1 hour, at most about 50 minutes, at most about 40 minutes, or at most about 30 minutes. This includes embodiments wherein the electrospinning step is performed for lengths of time ranging from about 5 minutes to about 8 hours, including, but not limited to, lengths of time ranging from about 10 minutes to about 4 hours, and ranging from about 30 minutes to about 3 hours.

Electrospinning Solutions

In some embodiments, the electrospinning solution may comprise between about 5 wt % and about 25 wt % of the polymer. For example, the electrospinning solution may comprise at least about 5 wt % of the polymer, such as at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, or at least about 24 wt % of the polymer. In some embodiments, the solution may comprise at most about 25 wt %, such as at most about 24 wt %, at most about 23 wt %, at most about 22 wt %, at most about 21 wt %, at most about 20 wt %, at most about 19 wt %, at most about 18 wt %, at most about 17 wt %, at most about 16 wt %, at most about 15 wt %, at most about 14 wt %, at most about 13 wt %, at most about 12 wt %, at most about 11, at most about 10, at most about 9, at most about 8, at most about 7, or at most about 6 wt % of the polymer. This includes, but is not limited to, embodiments wherein the solution comprises between about 7.5 wt % and about 22.5 wt %, between about 10 wt % to about 20 wt %, and between about 12.5 wt % to about 17.5 wt % of the polymer.

In some embodiments, the solution may comprise between 0 wt % and about 0.5 wt % of of carbon nanoparticles, such as MWNTs, EPC nanorods or AC nanorods. For example, the electrospinning solution may comprise at least about 0.01 wt % carbon nanoparticles, such as at least about 0.02 wt %, at least about 0.03 wt %, at least about 0.04 wt %, at least about 0.05 wt %, at least about 0.06 wt %, at least about 0.07 wt %, at least about 0.08 wt %, at least about 0.09 wt %, at least about 0.10 wt %, at least about 0.15 wt %, at least about 0.20 wt %, at least about 0.25 wt %, at least about 0.30 wt %, at least about 0.35 wt %, at least about 0.40 wt %, or at least about 0.45 wt % carbon nanoparticles. The electrospinning solution may comprise at most about 0.5 wt % carbon nanoparticles, such as at most about 0.45 wt %, at most about 0.40 wt %, at most about 0.35 wt %, at most about 0.30 wt %, at most about 0.25 wt %, at most about 0.20 wt %, at most about 0.15 wt %, at most about 0.10 wt %, at most about 0.09 wt %, at most about 0.08 wt %, at most about 0.07 wt %, at most about 0.06 wt %, at most about 0.05 wt %, at most about 0.04 wt %, or at most about 0.03 wt % carbon nanoparticles. This includes, but is not limited to, embodiments wherein the solution comprises between about 0.05 wt % and about 0.45 wt %, and between about 0.10 wt % and about 0.40 wt % carbon nanoparticles.

In general, the electrospinning solutions can comprise any solvent suitable for use in electrospinning. For example, the elctrospinning solutions may comprise DMF, among others.

### EXAMPLES

Exemplary embodiments of the present invention are provided in the following examples. The following examples are presented to illustrate the present invention and to assist one of ordinary skill in making and using the same. The examples are not intended in any way to otherwise limit the scope of the invention.

### Example I

### Materials and Methods

Materials

PAN (M_{w}=150,000 g/mol), MWNTs (>90%) with a diameter of 10-15 nm and N,N-dimethylformamide (DMF) were purchased from Sigma Aldrich (Atlanta, Ga.). The substrate for the electrospun fibers was Reynolds Wrap Super Strength Aluminum Foil (thickness 34.8 μm). The TLC analytes were four laser dyes: rhodamine 590 chloride, rhodamine 610 chloride, sulforhodamine 640 and kiton red from Exciton Inc. (Dayton, OH), four PAHs: phenanthrene, chrysene, and benzo[a]pyrene from Sigma Aldrich and pyrene from Supelco Inc. (Bellefonte, Pa.), and three analgesic drug compounds: salicylic acid, acetanilide and phenacetin from Sigma Aldrich (Atlanta, Ga.). Methanol, 2-propanol, acetonitrile, cyclohexane, nitric acid and pyridine were supplied by Fisher Scientific (Fair Lawn, N.J.), and ethanol was acquired from Decon Labs Inc. (King of Prussia, Pa.). AR mesophase pitch was purchased from Mitsubishi Gas Chemical America, Inc. (New York, N.Y.).

Instrumentation

A quartz tube furnace from Thermo Electron Corporation, model Lindberg Blue TF55030A, was used for the preparation of the carbon nanorods. The morphology of the electrospun nanofibers was evaluated using a Hitachi S-4300 (Hitachi High Technologies America Inc., Pleasonton, Calif.) scanning electron microscope (SEM). Raman spectroscopy was performed using a Renishaw InVia Raman Microscope (Gloucestershire, UK) with laser excitation at 785 nm.

Preparation of Electrospinning Solutions

To enhance the dispersion of MWNTs in organic solvent, MWNTs were oxidized in 6 M HNO₃ for 12 hours under reflux, then filtered, washed by distilled water and dried for further use. DMF was used as the solvent for both MWNTs and PAN. The oxidized-MWNTs were well dispersed in DMF after sonication of 3 hours. PAN was dissolved in DMF by stirring at 55° C. for 5-6 hours. MWNTs and PAN were separately dissolved in DMF firstly. Electrospinning solutions comprising 0.05% by weight MWNT and 10% by weight PAN were prepared by adding 1 g of 0.25% MWNT-DMF suspension to 4 g 12.5% PAN-DMF solution, followed by stirring the mixture at room temperature until the solution was homogeneous. The MWNT in this solution amounted to 0.5% by weight of the total solids, and thus were used to form 0.5% MWNT-PAN electrospun composite fibers. Other electrospinning solutions were similarly prepared to yield 0.05% MWNT-PAN electrospun composite fibers and pure PAN fibers, where the concentration of PAN in each electrospinning solution was 10%.

Preparation of all carbon nanorods (i.e., EPC and AC nanorods) was carried out using AR mesophase pitch as the DLC carbon precursor and an aluminum oxide Whatman Anodisc (Germany) as the anchoring substrate. Anodiscs with pore diameters of 200 nm were used. A synthetic procedure previously described by Hurt et al. (C. Chem. Mater. 14 (2002) 4558) was utilized to generate the edge plane carbon nanorods. Briefly, the Anodisc was prepared by rinsing with acetone and drying under a stream of N₂(g). Following this cleaning step, the Anodisc was placed on top of 1 mL of a 1% (w/v) solution of AR mesophase pitch in pyridine in a watch glass. The pores of the Anodisc were filled by the AR mesophase solution; once the pores were filled, the pyridine was allowed to evaporate. The filled Anodisc was subsequently transferred to a furnace and was pyrolyzed. A forming gas mixture (95% N₂ and 5% H₂) was continuously flowed through the quartz tube throughout the pyrolysis. The pyrolysis program used to generate the edge plane carbon nanorods consisted of initially ramping the furnace to 300° C. at a ramp rate of 10° C/min and holding the furnace at that temperature for 4 hours. The temperature and duration of this initial hold time is critical to allow the AR mesophase to transition to a DLC and allow for edge-on surface anchoring of the DLC on the alumina oxide pore walls. The furnace is subsequently ramped to 700° C. at a ramp rate of 3.4° C/min and held at that temperature for 1 hour.

AC nanorods were prepared in a similar manner to the EPC nanorods. The introduction of the AR mesophase pitch to the Anodisc is identical; however the pyrolysis program is altered so that ordered surface anchoring of AR mesophase does not occur. There was no initial hold time at 300° C., rather, the temperature program for the amorphous carbon nanorods consisted of a 2.0° C/min ramp rate to a final temperature of 700° C., which was held for 1 hour. Since the DLC was not allowed to interact with the alumina oxide pore walls, ordering does not occur and amorphous carbon nanorods are generated.

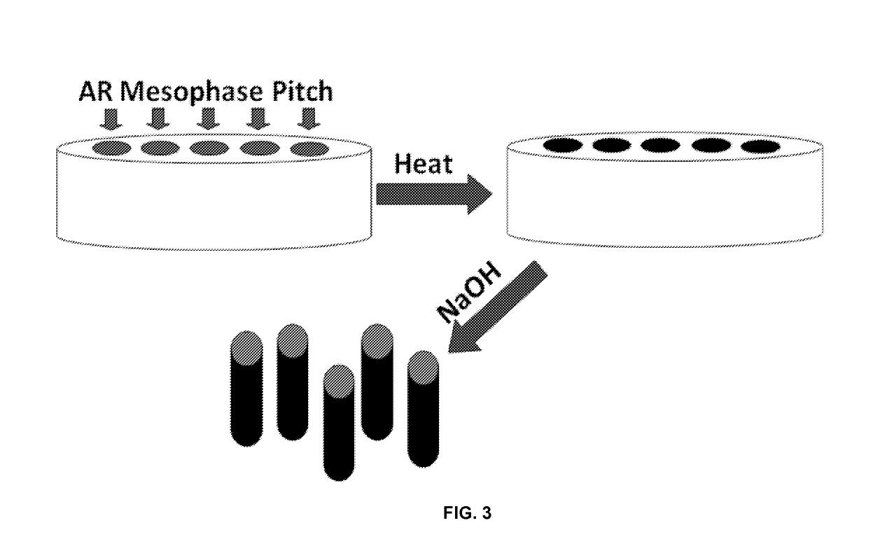

Following pyrolysis, the Anodiscs were allowed to cool to room temperature and were subsequently immersed in a 0.4 M NaOH solution, where the aluminum oxide was dissolved thus freeing the carbon nanorods. The carbon nanorods were then transferred into an aqueous solution and repeatedly washed and centrifuged until the solution of carbon nanorods reached a pH of 7.0. The solvent was subsequently evaporated to isolate the carbon nanorods. This synthetic procedure is graphically summarized in FIG. 3. The isolated carbon nanorods were characterized using scanning electron microscopy (SEM) and transmission electron microscopy (TEM).

Electrospinning solutions containing carbon nanorods and PAN were prepared by first dispersing 2.5 mg EPC nanorods or AC nanorods in 4.5 g DMF by sonication for 5 hours. Then 0.5 g PAN was added into the above dispersion and the mixture was stirred at 55° C. for 5-6 hours. This provided electrospinning solutions comprising 0.05% by weight EPC or AC nanorods, and 10% by weight PAN. The nanorods in these solutions amounted to 0.5% by weight of the total solids, and thus were used to form 0.5% EPC-PAN or AC-PAN electrospun composite nanofibers. Other electrospinning solutions were similarly prepared to yield 0.05% EPC-PAN or AC-PAN electrospun composite fibers, where the concentration of PAN in each electrospinning solution was 10%.

Electrospinning

The electrospinning apparatus utilized to fabricate composite nanofibers was previously described (Anal. Chem. 2009, 81, 4121-4129; J. Chromatogr. A 2010, 1217, 4655-4662; Anal. Chim. Acta. Submitted. 2012). In a typical electrospinning process, the polymer solution was loaded in a plastic syringe and pumped at a flow rate of 20 μL/min. A high electrical potential of 20 kV was applied across the syringe tip and the aluminum foil collector. The distance between the tip and the collector was kept at 10 cm. The relative humidity in the electrospinning enclosure was maintained at ˜25% using N₂ flow. The electrospun fibers were randomly distributed forming a uniform fiber mat on the aluminum foil. Each electrospinning trial was run for 10 min to form a mat thickness of ˜25 μm.

Thin Layer Chromatography

After electrospinning, each nanofiber mat was cut into a rectangular plate (2×5 cm) from the central portion for UTLC experiments. A glass capillary with an internal diameter of 100 μm was used to spot analytes. The amount of analytes spotted was calculated from the difference of liquid volume in the capillary before and after sampling, which was ˜25 nL for laser dyes and analgesic drugs, and ˜50 nL for PAH compounds. All TLC plates were developed in a cylindrical glass chamber until the mobile phase reached a migration distance of 25 mm. The detailed TLC process was previously described (Anal. Chem. 2009, 81, 4121-4129; J. Chromatogr. A 2010, 1217, 4655-4662; Anal. Chim. Acta. 2013, 761, 201-208.). The optimized mobile phase for laser dyes analysis was 2-propanol/methanol 80:20 (v/v), for PAHs separation was acetonitrile/water 70:30 (v/v), and for analgesic drugs was methylene dichloride/hexane 10:90 (v/v). After development, TLC plates were taken out of the chamber, dried at room temperature, and then visualized under ultraviolet radiation at 254 nm. A digital photograph was obtained for each separation using a Canon A650IS 12.1 MP digital camera, and then analyzed using ImageJ and PeakFit software for the calculation of chromatographic parameters.

### Example II

### Formation of Carbon Nanofiber-Polymer or Nanorod-Polymer Composite Electrospun Nanofibers

The successful fabrication of carbon nanofiber-polymer or nanorod-polymer composite fibers depends on the successful dispersion of the carbon materials within the polymer. However, MWNTs and carbon nanorods naturally assemble themselves into bundles via van der Waals forces, which hinders their dispersion in most organic solvents. To address this issue, several strategies have been developed, including physical mixing, chemical functionalization, and use of surfactants.

In this disclosure, carbon nanorods synthesized from template-directed liquid crystal method showed higher dispensability in DMF than as-received MWNTs. Both EPC nanorods and AC nanorods could be homogeneously dispersed into DMF by sonication for 5 hours. However, the as-received MWNTs need to be treated by reflux in 6 M HNO₃ for 12 hours before using. The treatment of HNO₃ resulted in the presence of carboxylic acid groups (—COOH) on the surface. Similar processes have been previously reported, showing the carboxylic groups identified by Fourier-transform infrared spectroscopy (FT-IR) (Chem. Mater. 2005, 17, 967-973; J. Am. Chem. Soc. 2003, 125, 9761-9769). The attached carboxylic acid groups can prevent aggregation of MWNTs in the solvent by overcoming van der Waals attractions between MWNT bundles and developing stronger interactions with solvent molecules. After surface oxidization, the MWNT-DMF suspension (0.5%) was stable for two weeks without precipitation observed. When as-received MWNTs were electrospun with PAN, SEM images showed black agglomerates among the nanofibers. The formation of black agglomerates, probably due to the aggregation of MWNTs, would reduce the quality of the stationary phase. However, the oxidized MWNTs were well dispersed in polymer solution. SEM images showed uniform structure of the composite fibers, without black agglomerate observed. The functionalization of MWNTs surface not only increases the dispersibility of MWNTs in organic solvent, but also strengthens the interfacial bonding between MWNTs and the polymer matrix. The acid treatment leads to production of shorter MWNTs, causes end-open of nanotubes, and creates defect sites on the graphene sheet walls.

During the electrospinning process, PAN matrix undergoes a drawing effect, which induces the alignment of carbon nanotubes/nanorods along the flow direction. As a result, most embedded nanotubes/nanorods maintain their straight shape and orient parallel to the fiber axis. Several mechanisms have been suggested to describe the molecular interaction between the carbon surface and PAN in composite fibers, and most of them pointed towards bonding of π-electrons in carbon surface with the nitrile groups (—CN) of PAN as the main interaction.

### Example III

### Characterization of Carbon Nanoparticle-PAN Composite Electrospun Nanofibers

MWNT-PAN Nanofibers

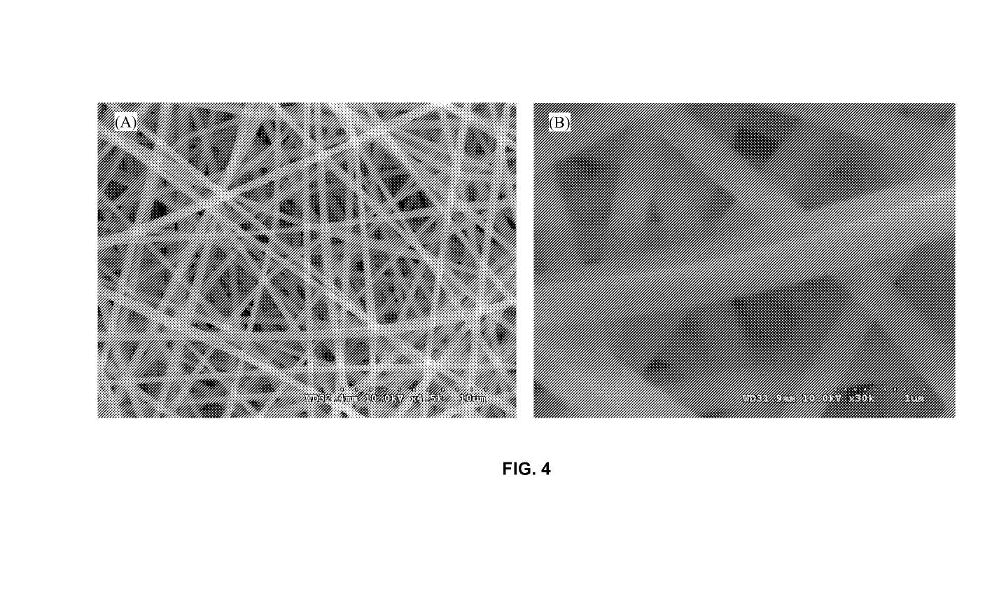

The morphology, diameter and mat thickness of MWNT-PAN composite nanofibers were characterized by SEM. The SEM images in FIG. 4 shows that the composite fibers containing 0.5% MWNTs exhibit nanofibrous morphology similar to that of pure PAN fibers (See, e.g., Chem. Mater. 2005, 17, 967-973; Nano Lett. 2004, 4, 459-464). High magnification of the composite fibers (FIG. 4B) shows a relatively smooth surface, indicating that most MWNTs are embedded into the nanofiber matrix. Table 1 below shows the average diameter and mat thickness of electrospun fibers with different concentration of MWNTs generated at an electrospinning time of 10 minutes. As the concentration of MWNTs increased, more MWNTs are embedded into the nanofibers, leading to a larger fiber diameter. However, the mat thickness of the stationary phase varies very little when increasing the concentration of MWNTs up to 0.5%. At an electrospinning time of about 10 minutes, all stationary phases have thicknesses around 23-25 μm, feasible for UTLC according to previous reports.

TABLE 1
Summary of SEM measured fiber diameter and mat thickness
for stationary phases containing 0, 0.05, and 0.5% MWNTs.

| Concentration of MWNTs | Fiber Diameter | Mat Thickness |
|---|---|---|
| in Stationary Phase | (nm) | (μm) |
| 0% | 330 ± 30 | 25 ± 2.7 |
| 0.05% | 335 ± 30 | 25 ± 1.8 |
| 0.5% | 360 ± 35 | 23 ± 3.0 |

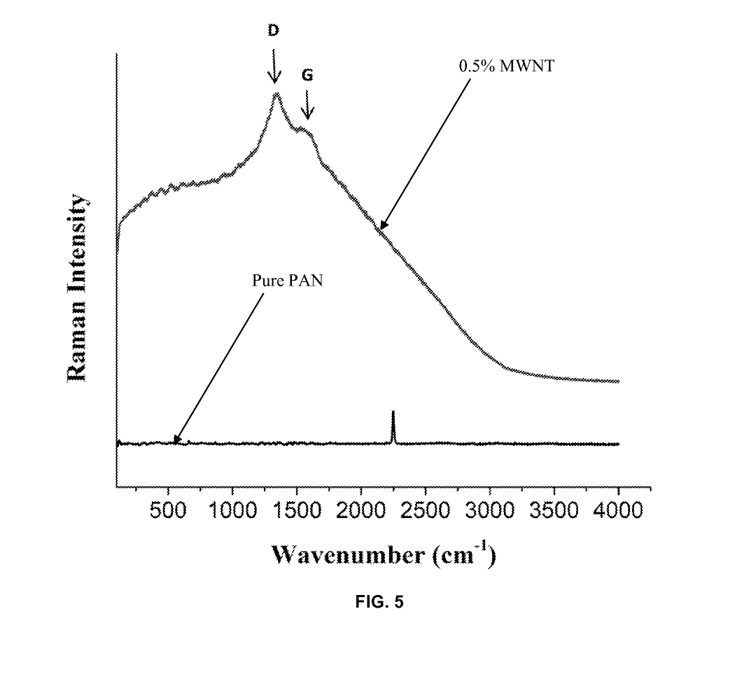

While the pure PAN fibers were white, the addition of MWCNTs changed the color of the mat to gray, suggesting the MWNT were incorporated into the nanofibers. Raman spectroscopy was used to confirm the incorporation of MWNT in the PAN fibers. FIG. 5 compares the Raman spectra of 0.5% MWNT-PAN composite fibers to that of pure PAN fibers. Two typical peaks associated with MWNTs are D-band at ˜1350 cm⁻¹ and G-band at ˜1580 cm⁻¹, which are observed in MWNT-PAN fibers, but not present in pure PAN fibers. The G-band is a characteristic feature of the graphitic layers and corresponds to tangential vibration of the carbon atoms. The D-band is a typical sign for defective graphitic structure, and is observed in sp² carbons containing porous, impurities, or symmetry-breaking defects. The spectra of pure PAN fibers is featureless in the range of 500-2000 cm⁻¹. The peak at 2240 cm⁻¹ is attributed to the nitrile group (—CN) in PAN. Additionally, MWNT-PAN composite fibers exhibit broad luminescence emissions owing to the trapping of excitation energy at defect sites in MWNTs induced by the chemical functionalization process. These observations confirm the successful filling of MWNTs in PAN nanofibers.

EPC-PAN and AC-PAN Nanofibers

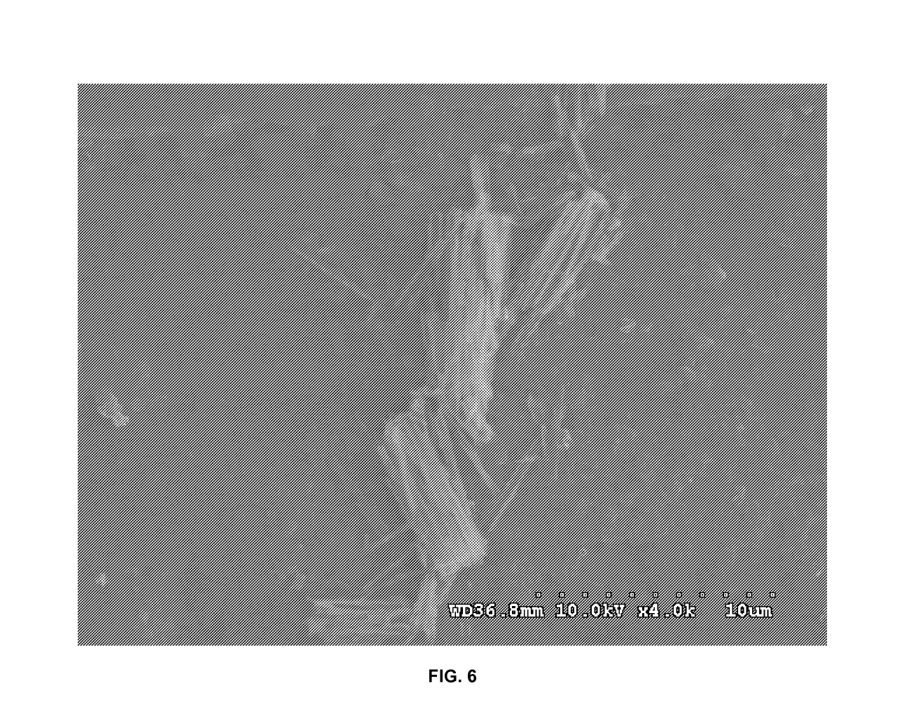

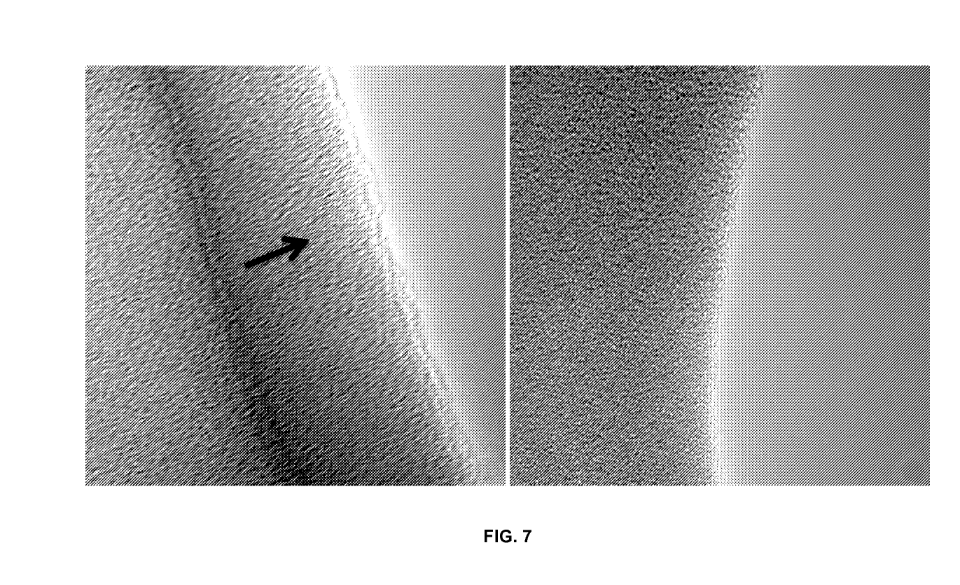

EPC and AC nanorods were synthesized according to the procedure stated above. Once the carbon nanorods were removed from the Anodisc and neutralized by washing, they were characterized using SEM and TEM. FIG. 6 shows an SEM image of multiple EPC nanorods, which have average diameters of around 200 nm, corresponding to the pore sizes of the Anodisc. While SEM is useful for observing the surface and dimensions of the carbon nanorods, TEM was used to confirm whether or not carbon sheets that comprise the nanorods are aligned or amorphous. FIG. 7 shows TEM images of an EPC nanorod (left) and an AC nanorod (right), respectively. The arrow on the TEM image of the EPC nanorod shows the direction of the alignment of the carbon sheets; in the case of edge-plane carbon, this direction is normal to the surface of the nanorod. The TEM image of the AC nanorod shows no discernible alignment.

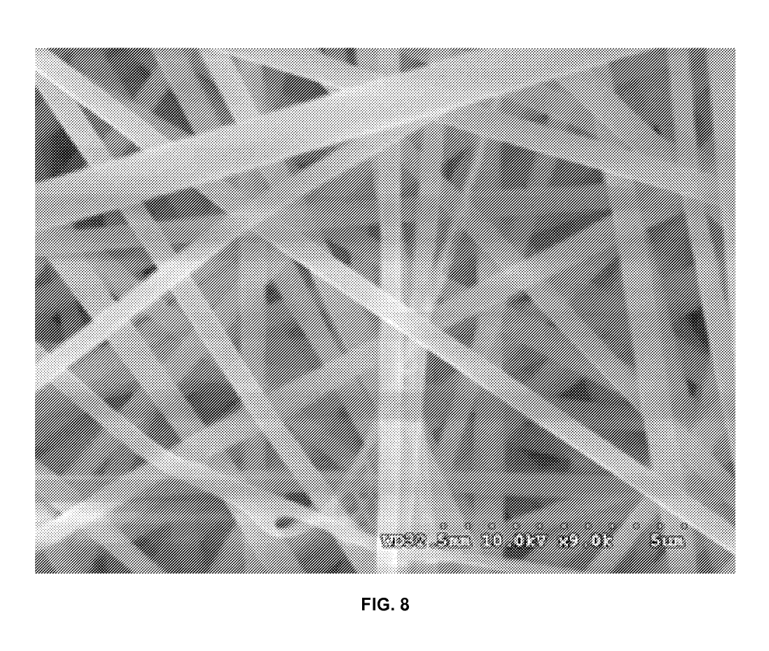

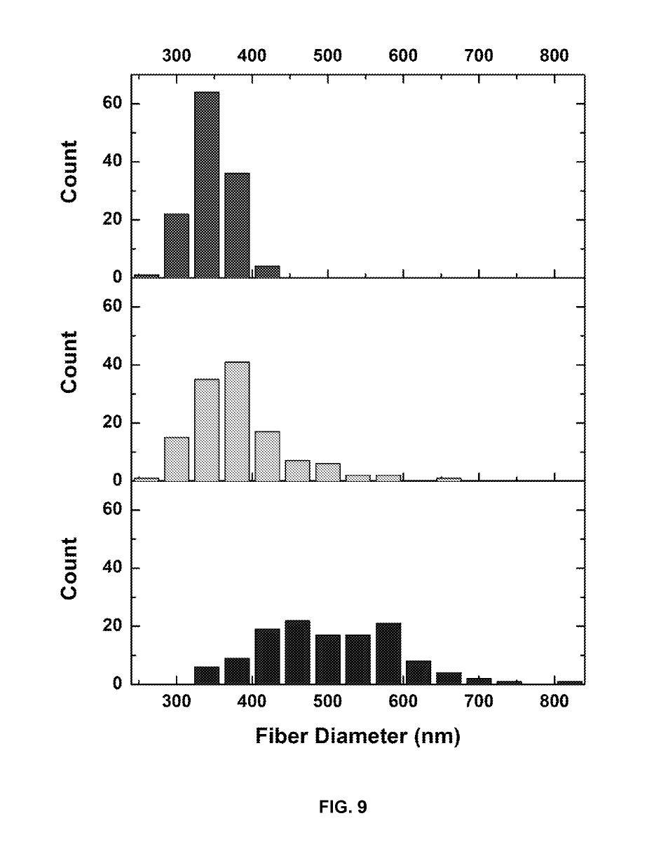

The morphology, diameter and mat thickness of EPC-PAN and AC-PAN electrospun composite nanofibers were characterized by SEM. FIG. 8 shows an SEM image of 0.5% EPC-PAN composite nanofibers. Due to the relatively large size of carbon nanorods, a few nanorods were not completely embedded into PAN fibers and extruded at one end. FIG. 9 shows the distribution of fiber diameter for nanofibers with different concentrations of EPC nanorods. It was obvious that the fiber diameter increased with increasing concentration of EPC nanorods, and so does the distribution width. 0.5% EPC-PAN composite nanofibers clearly had more EPC nanorods embedded into the fibers, giving a large average fiber diameter of ˜490±90 nm. However, the wide distribution of fiber diameter at high concentration may cause increased band broadening during the separation process.

### Example IV

### Analysis of Laser Dyes

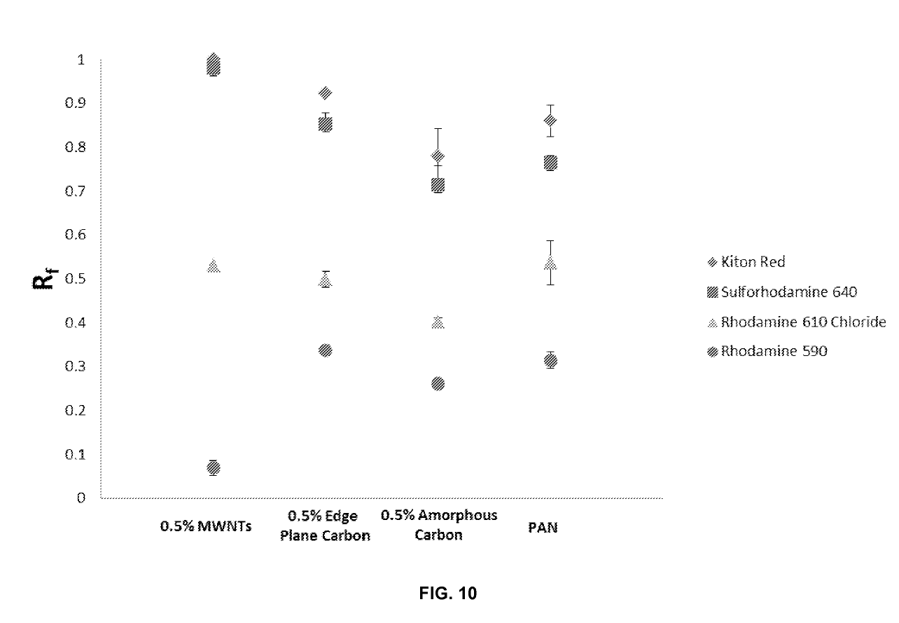

Laser dyes were used as test analytes to initially verify the suitability of electrospun composite nanofibers for TLC separations. To confirm that the adding of carbon nanoparticles to stationary phase does not disrupt its nano-structure suitable for TLC separation, a set of four laser dyes, rhodamine 590 chloride, rhodamine 610 chloride, sulforhodamine 640, and kiton red were analyzed on MWNT, edge plane carbon nanorods and amorphous carbon nanorods—filled plates and pure PAN plates. Each carbon-filled UTLC plates contained the same amount of carbon nanoparticles, which was 0.5% out of the polymer. The concentration of each laser dye in ethanol was 10⁻⁵ M except for kiton red (5×10⁻⁵ M). FIG. 10 shows the retention factors R_{f}, of four laser dyes calculated from Equation 1, where Z_{f} is the distance travelled by solvent front and Zₛ is the distance travelled by analytes.

$${R}_{f} = \frac{{Z}_{s}}{{Z}_{f}} \qquad ( 1 )$$

Due to different chemical functionalities present in the selected laser dyes, the change in retention caused by incorporation of MWNTs was not identical for each of them. Compared with pure PAN plate, rhodamine 590 chloride and rhodamine 610 chloride showed slightly increased retention on MWNT-PAN UTLC plate, while sulforhodamine 640 and kiton red were less retained. No obvious differences were observed in retention factors between the EPC-PAN UTLC plate and the pure PAN UTLC plate. However, all four laser dyes showed increased retention on the AC-PAN plate than the EPC-PAN plate. Comparing the three carbon nanoparticle-PAN UTLC plates, filling of MWNTs in the stationary phase demonstrated best separation of laser dyes by showing the largest differences in retention factors. The above results suggest that carbon nanoparticle-PAN nanofibers retained their suitability as UTLC stationary phase.

### Example V

### Separation of Polycyclic Aromatic Hydrocarbons

Polycyclic Aromatic Hydrocarbons (PAHs) are environmental pollutants that consist of fused aromatic rings and do not carry substituents. They are produced during burning processes, and are usually present in the atmosphere, contaminated plants and cooked food. Silica gel-coated TLC has been reported for the determination of PAHs in vegetables, airborne particulate matter, and automobile exhaust gases. As a group of non-polar compounds, PAHs may develop strong interactions with carbon-filled stationary phase and cause a difference in retention behavior. Therefore, they were chosen as analytes to test the performance of carbon-filled UTLC plates. The separation of four PAH compounds, phenanthrene, pyrene, chrysene, and benzo[a]pyrene were performed on each carbon nanoparticle-filled plate and pure PAN plate. Cyclohexane was used to dissolve all analytes to the concentration of 10⁻³, 10⁻³, 10⁻³, 2×10⁻⁴ M, respectively. Acetonitrile/water was chosen as the binary solvent system for a reversed-phase TLC condition.

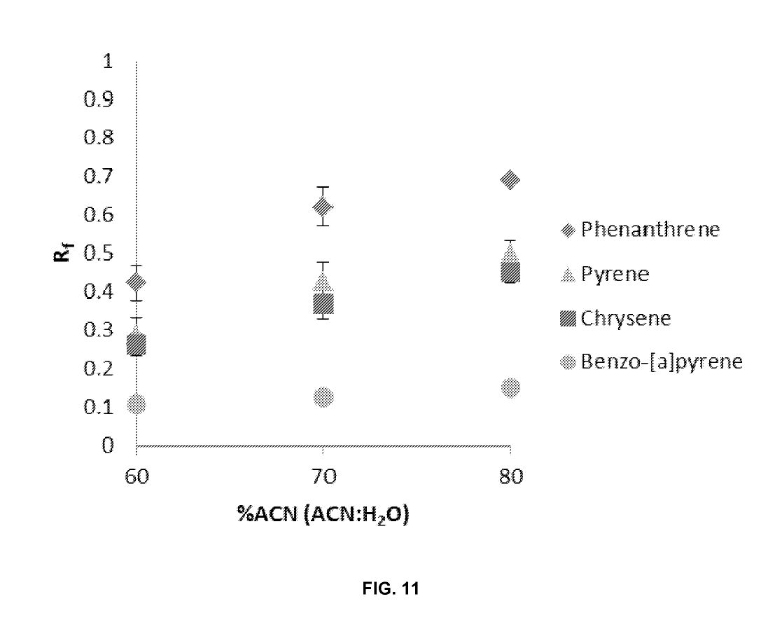

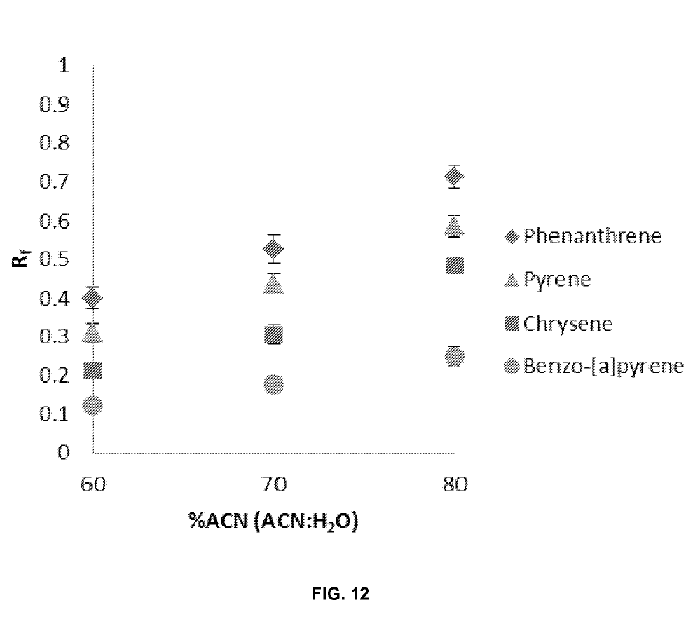

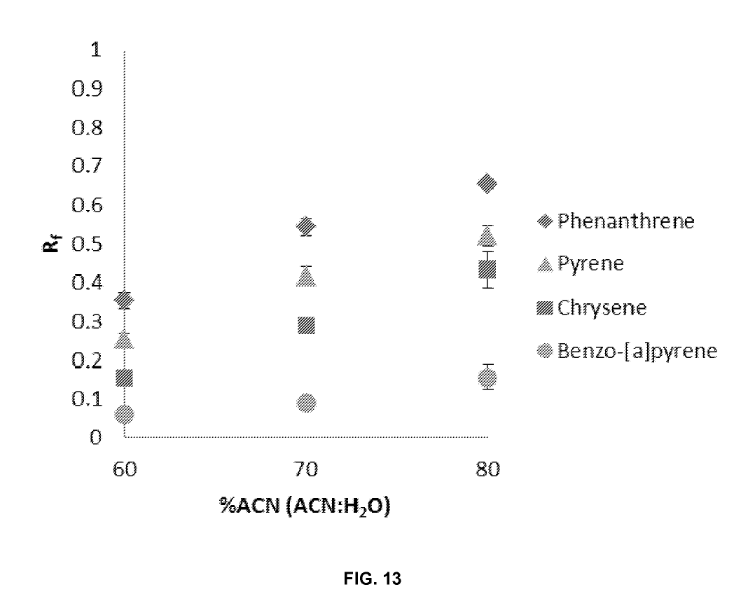

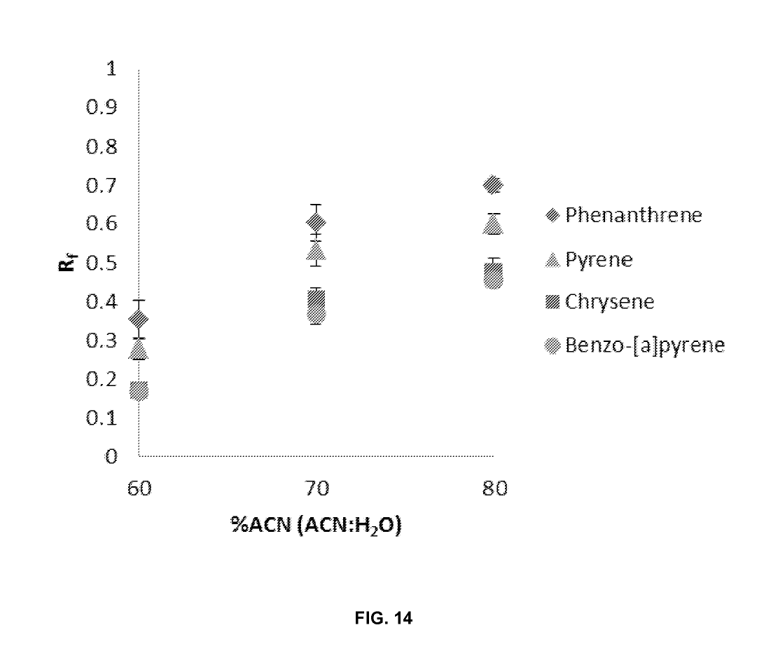

FIGS. 11-14 show the retention behavior of each compound under different mobile phase compositions for 0.5% MWNT-PAN plates (FIG. 11), 0.5% EPC-PAN plates (FIG. 12), 0.5% AC-PAN plates (FIG. 13) and pure PAN plates (FIG. 14). Not surprisingly, the order of migration (most to least retained) on all plates exhibits good agreement with the increasing polarity of the analytes. The most retained compound is benzo[a]pyrene which consists of five aromatic rings and thus interacts strongly with the non-polar stationary phase. The least retained analyte is phenanthrene which contains only three benzene rings. Compared with pure PAN stationary phase, the differences of retention factors on all carbon-filled plates are much broader. Both AC-PAN plates and MWNT-PAN plates give better separation of PAH compounds than EPC-PAN plates and pure PAN plates. However, the resolution between pyrene and chrysene is limited on MWNT-PAN plates. Pure PAN plates exhibit poor resolution and selectivity for nonpolar PAH compounds, showing chrysene and benzo[a]pyrene overlaps with each other.

The incorporation of carbon nanoparticles in PAN nanofibers makes the stationary phase more hydrophobic. As can be observed in FIGS. 11-14, the retention of each analyte increased when the stationary phase included carbon nanoparticles. The increased retention can be attributed to enhanced π-π interactions occurring between the highly aromatic PAH compounds and the carbon materials in the stationary phase. MWNTs can be thought of as graphite planes rolled up into cylinders with the surface consisting of regular hexagons. Analytes may be drawn onto the nanotube surface or channels between nanotube bundles due to their surface tension and capillary effects, and therefore exhibit stronger retention behavior. The ratio of R_{f} values on EPC-PAN plates to R_{f} values on AC-PAN plates under different mobile phase compositions were calculated and listed in Table 2, below.

TABLE 2
Comparison of R_{f} on edge plane carbon-filled plate
over R_{f} on amorphous carbon-filled plate under
different mobile phase compositions for four PAHs.

| | R_{f} on EPC Plates/R_{f} on Amor. C Plates under | | |
|---|---|---|---|
| | Different Mobile Phase (ACN:H2O) Composition | | |
| Compound | 60% ACN | 70% ACN | 80% ACN |
| Phenanthrene | 1.13 | 0.97 | 1.09 |
| Pyrene | 1.22 | 1.04 | 1.13 |
| Chrysene | 1.36 | 1.06 | 1.12 |
| Benzo-[a]pyrene | 2.05 | 1.96 | 1.60 |

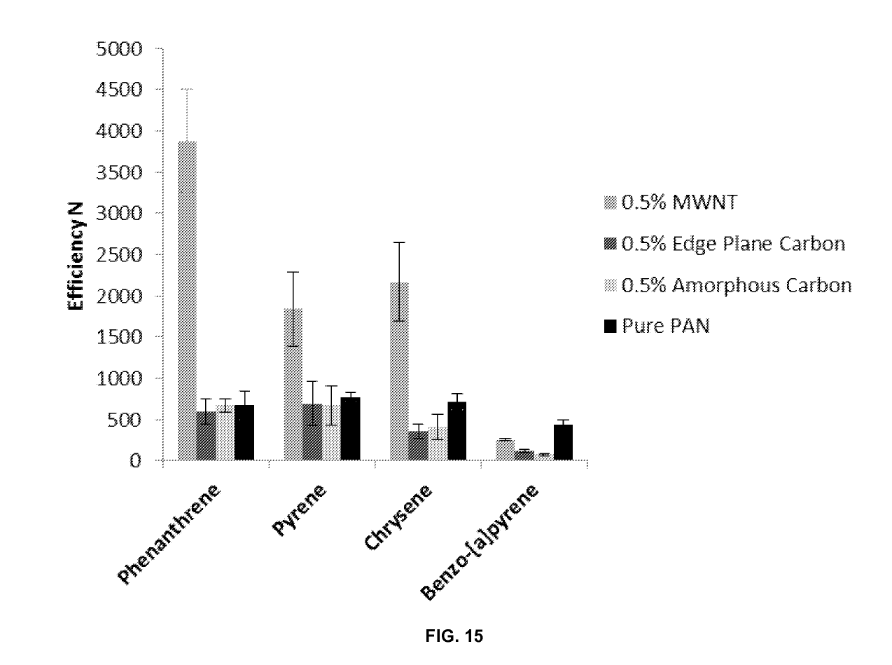

Most of the ratios are larger than 1, indicating that nonpolar PAH compounds are more retained on AC-PAN plates than EPC-PAN plates. This result can be explained by the fact that amorphous carbon contains basal plane sites which can involve more π-π interactions with the highly aromatic PAH compounds. A mobile phase of 70:30 acetonitrile/water resulted in the best separation (both minimized band broadening and large differences in selectivity) and thus was chosen to calculate the separation efficiency and resolution for all carbon nanoparticle-PAN plates and pure PAN plate. FIG. 15 gives the separation efficiency described by theoretical plate number, N for each plate calculated from equation 2, where Zₛ is the distance travelled by the analyte, and w is the developed spot width.

$$N = 16 {( \frac{{Z}_{s}}{w} )}^{2} \qquad ( 2 )$$

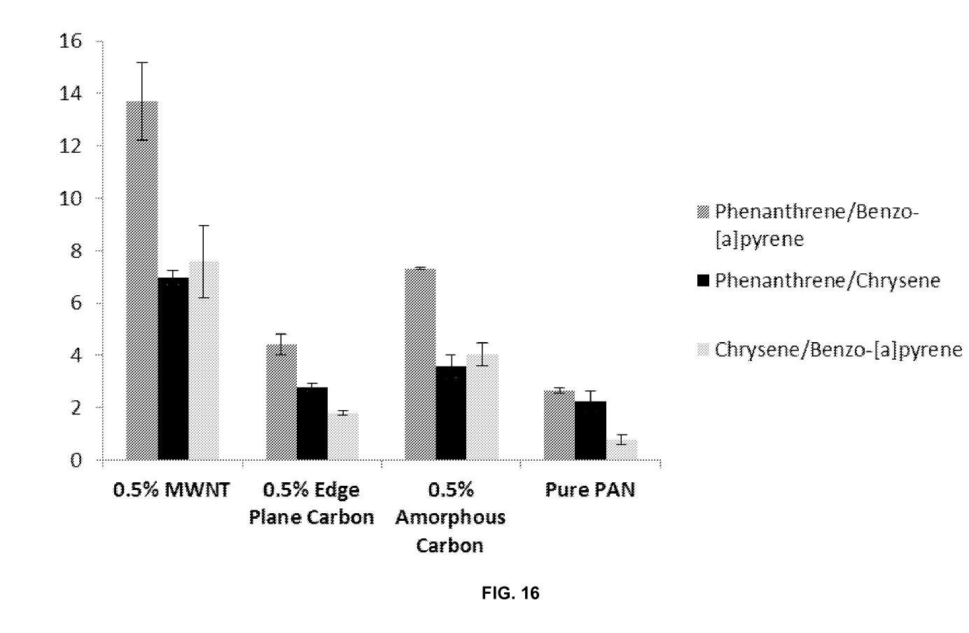

Clearly, filling of MWNTs in the stationary phase increases the separation efficiency of all PAHs by 2-6 times except for benzo[a]pyrene, which was strongly retained on MWNT-PAN plate. Equation 2 predicts that the improvement of separation efficiency results from both enhanced migration distance of analyte and diminished spot size. Since the migration distances of PAHs were similar on both plates under the optimum condition, the increased theoretical plate number mainly originated from decreased spot size (diminished zone broadening) on the MWNT-PAN plate. However, EPC-PAN and AC-PAN plates did not exhibit better separation efficiency for PAH compounds than pure PAN. Large spot size (band broadening) caused by wide distribution of fiber diameter and short migration distance of the analytes are thought to be responsible for the limited efficiency observed on both plates. FIG. 16 compares the resolution of three PAHs on all plates. MWNT-PAN plates represented highest resolution, followed by AC-PAN plates, EPC-PAN plates and pure PAN plates.

Band broadening caused by three different processes in chromatography is expressed by the van Deemter equation,

$$H = A + \frac{B}{u} + Cu \qquad ( 3 )$$

where H is the height equivalent to a theoretical plate, and u is the solvent velocity. In this equation, the A term results from sample molecules experiencing unequal flow velocities as they travel different pathways through the packing material. Compared to B and C, A is rather small for fine particles (diameters below 10 μm), and is therefore negligible. B is the term involving longitudinal molecular diffusion in the mobile phase and becomes less important with increasing mobile phase velocity. The C term expresses nonequilibrium resulting from resistance to mass transfer between mobile phase and stationary phase. Under capillary-flow-controlled conditions, the mobile phase velocities are too slow for resistance to mass transfer (C term) to be a significant contributor to zone broadening. Therefore, zone broadening in this case is largely dominated by B term, longitudinal diffusion which is inversely proportional to the mobile phase velocity. For the separation of PAHs, the mobile phase travels at a speed two times faster on MWNT-PAN plates than that on EPC-PAN plates and pure PAN plates, thus resulting in ˜50% decrease in average plate height. Fast mobile phase transport, which results in suppressed longitudinal diffusion, is thought to be responsible for the increased theoretical plate number observed on MWNT-PAN plates. EPC-PAN plates and pure PAN plates show similar solvent migration velocities, and therefore give the same magnitude of band broadening.

### Example VI

### Separation of Analgesic Drugs

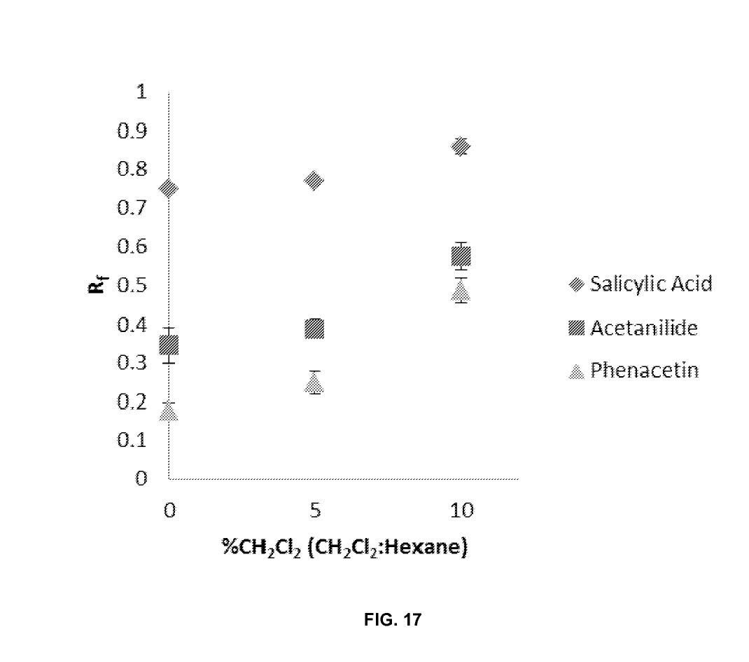

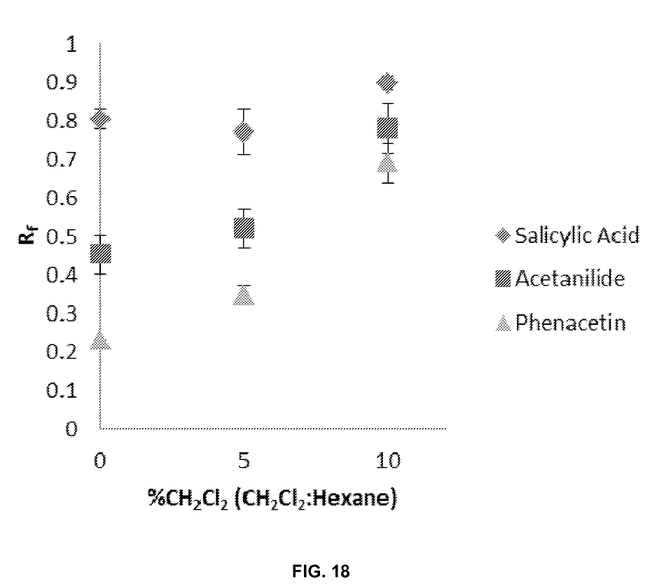

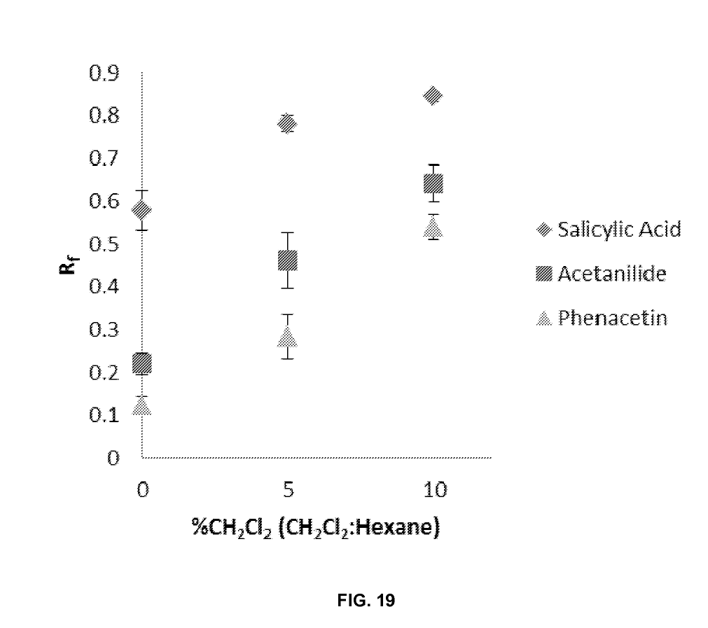

In order to further study the selectivity differences between EPC-PAN UTLC plates and AC-PAN UTLC plates, separation of three analgesic drugs: salicylic acid, acetanilide and phenacetin was performed. Ethanol was used to dissolve all analytes to concentrations of 1.0 mg/mL. Methylene/hexane was chosen as the binary solvent system for a reversed-phase TLC condition. FIGS. 17-19 show the retention factors for each compound under different mobile phase compositions for 0.5% EPC-PAN plates (FIG. 17), 0.5% AC-PAN plates (FIG. 18) and pure PAN plates (FIG. 19). The three analgesic drugs were well separated on all plates, and no obvious differences in retention factors were noted. Table 3 lists the ratio of R_{f} values on EPC-PAN plates over R_{f}values on amorphous carbon plate.

TABLE 3
Comparison of R_{f} on EPC-PAN plates over R_{f}
on AC-PAN plates under different mobile phase
compositions for three analgesic drugs.

| | R_{f} on EPC-PAN Plates/R_{f} on AC-PAN | | |
|---|---|---|---|
| | Plates under Different Mobile Phase | | |
| | (CH₂Cl₂:Hexane) Composition | | |
| Compound | 0% CH₂Cl₂ | 5% CH₂Cl₂ | 10% CH₂Cl₂ |
| Salicylic Acid | 0.93 | 0.76 | 0.77 |
| Acetanilide | 1.00 | 0.75 | 0.72 |
| Phenacetin | 0.96 | 0.74 | 0.70 |

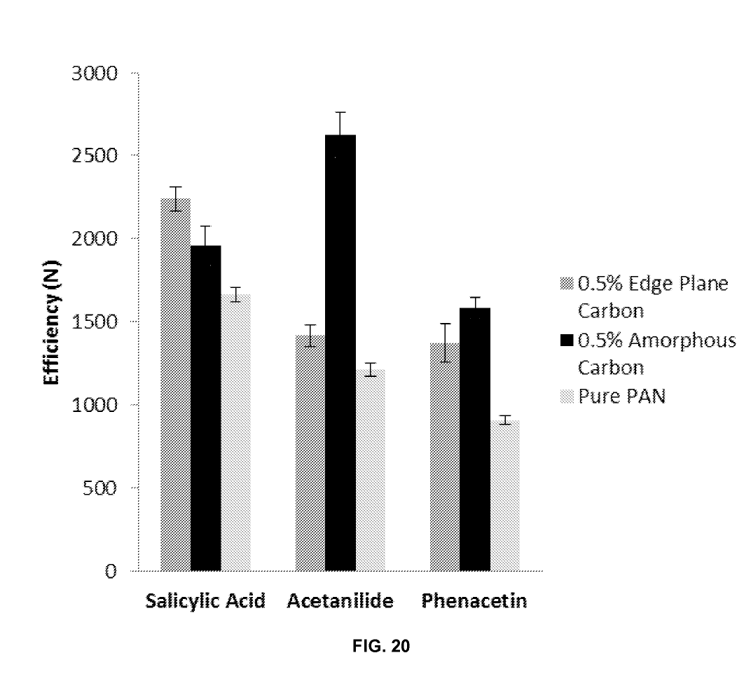

Most ratio values are smaller than 1, indicating that all analgesic drugs were more retained on EPC-PAN UTLC plates. The three analgesic compounds may develop stronger interaction with edge plane carbon in the stationary phase through their functional groups. Due to the similarity in their functional groups, the differences in selectivity between them were not shown. FIG. 20 shows that EPC-PAN plates and AC-PAN plates have similar separation efficiency for most analgesic drugs. Dramatic increase in efficiency was noted only for acetanilide on AC-PAN plates due to its longest migration distance. However, in all cases, the addition of carbon unexpectedly improves the efficiency.

### CONCLUSIONS

Oxidized MWNTs, edge plane ordered carbon nanorods and amorphous carbon nanorods were prepared and included separately into PAN electrospun nanofibers as UTLC stationary phases. The incorporation of carbon nanoparticles into UTLC stationary phases offered increased selectivity for nonpolar analytes. MWNT-filled UTLC devices demonstrate enhanced resolution and separation efficiency for the analysis of both laser dyes and PAH compounds. The incorporation of MWNTs tailors the surface selectivity of the stationary phase by developing strong π-π interactions with the highly aromatic analytes. EPC-PAN and AC-PAN UTLC plates showed different selectivity to PAH compounds and analgesic drugs. Amorphous carbon contains basal plane sites which can develop stronger π-π interactions with PAHs, while edge plane carbon interacts more with analgesic drugs through their functional groups. Analytes with different functional groups need to be further tested to better understand selectivity differences between stationary phases comprising edge-plane ordered carbon and amorphous carbon.

### REFERENCES

The following references are hereby incorporated by reference in their entireties:
Poole, C. F. The Essence of Chromatography; Elsevier Science: Amsterdam, The Netherlands, 2003.
Fried, B.; Sherma, J. Thin-Layer Chromatography, 4^{th} ed.; Marcel Dekker: New York, U.S.A., 1999.
Costanzo, S. J. J. Chem. Educ. 1984, 61, 1015-1018.
Hauck, H. E.; Schulz, M. J. Chromatogr. Sci. 2002, 40, 550-552.
Clark, J. E.; Olesik, S. V. Anal. Chem. 2009, 81, 4121-4129.
Clark, J. E.; Olesik, S. V. J. Chromatogr. A 2010, 1217, 4655-4662.
Beilke, M. C.; Zewe, J. W.; Clark, J. E.; Olesik, S. V. Anal. Chim. Acta. 2013, 761, 201-208.
Jim, S. R.; Taschuk, M. T.; Morlock, G. E.; Bezuidenhout, L. W.; Schwack, W.; Brett, M. J. Anal. Chem. 2010, 82, 5349-5356.
Ye, H.; Lam, H.; Titchenal, N.; Gogotsi, Y.; Ko, F. Appl. Phys. Lett. 2004, 85, 1775-1777.
Ramakrishna, S.; Fujihara, K.; Teo, W.; Lim, T. C.; Ma, Z. An Introduction to Electrospinning and Nanofibers; World Scientific Publishing: Toh Tuck Link, Singapore, 2005.
Hou, H.; Ge, J. J.; Zeng, J.; Li, Q.; Reneker, D. H.; Greiner, A.; Cheng, S. Z. D. Chem. Mater. 2005, 17, 967-973.
Pereira, L.; J. Liq. Chromatogr. & Rel. Tech. 2008, 31, 1687.
Saridara, C.; Mitra, S. Anal. Chem. 2005, 77, 7094-7097.
Kama, M.; Mitra, S. Anal. Chem. 2006, 78, 2064-2070.
Zhu, X. Y.; Lee, S. M.; Lee, Y. H.; Frauenheim, T. Phys. Rev. Lett. 2000, 85, 2757-2760.
Trojanowicz, M. Trends Anal. Chem. 2006, 25, 480-489.Hussain, C. M.; Saridara, C.; Mitra, S. Anal. Chem. 2010, 82, 5184-5188.
Valcarcel, M.; Cardenas, S.; Simonet, B. M. Anal. Chem. 2007, 79, 4788-4797.
Li, Y.; Chen, Y.; Xiang, R.; Ciuparu, D.; Pfefferle, L. D.; Horvath, C.; Wilkins, J. A. Anal. Chem. 2005, 77, 1398-1406.
Jenkins, G. M.; Kawamura, K. Nature 1971, 231, 175.
Knox, J.; Ross, P. Advances in Chromatography 37 (1997) 73.
Brooks, J. D.; Taylor, G. H. Nature, 206 (1965) 697.
Hurt, R. H.; Chen, Z. Y.; Phys. Today. 53 (2000) 39.
Brooks, J. D.; Taylor, G. H. Carbon, 3 (1965) 185.
Perova, T. S.; Vij, J. K. Adv. Mater. 7 (1995) 919.
Jian, K.; Shim, H.-S.; Schwartzman, A.; Crawford, G. P.; Hurt, R. H. Adv. Mater. 15 (2003) 164.
Jian, K.; Xianyu, H.; Wakin, J.; Gao, Y.; Crawford, G. P.; Hurt, R. H. Carbon, 43 (2005) 407.
Chan, C.; Crawford, G.; Gao, Y.; Hurt, R.; Jian, K.; Li, H.; Sheldon, B.; Sousa, M.; Yang, N. Carbon, 43 (2005) 305.
Hurt, R.; Krammer, G.; Crawford, G.; Jian, K.; Rulison, C. Chem. Mater. 14 (2002) 4558.
Sen, R.; Zhao, B.; Perea, D.; Itkis, M. E.; Hu, H.; Love, J.; Bekyarova, E.; Haddon, R. C. Nano Lett. 2004, 4, 459-464.
Ge, J. J.; Hou, H.; Li, Q.; Graham M. J.; Greiner, A.; Reneker, D. H.; Harris, F. W.; Cheng, S. Z. D. J. Amer. Chem. Soc. 2004, 126, 15754-15761.
Hilding, J.; Grulke, E. A.; Zhang, Z. G.; Lockwood, F. J. Dispersion Sci. Technol. 2003, 24, 1-41.
Vaisman, L.; Wagner, H. D.; Marom, G. Adv. Colloid Interface Sci. 2006, 128-130, 37-46.
Andrews, R.; Weisenberger, M. C. Curr. Opin. Solid State Mater. Sci. 2004, 8, 31-37.
Kovtyukhova. N. I.; Mallouk, T. E.; Pan, L.; Dickey, E. C. J. Am. Chem. Soc. 2003, 125, 9761-9769.
Eitan, A.; Jiang, K.; Dukes, D.; Andrews, R.; Schadler, L. S. Chem. Mater. 2003, 25, 3198-3201.
Ayutsede, J.; Gandhi, M.; Sukigara, S.; Ye, H.; Hsu, C.; Gogotsi, Y.; Ko, F. Biomacromolecules 2006, 7, 208-214.
Wan, Y.; He, J.; Yu, J. Polym. Int. 2007, 56, 1367-1370.
Chronakis, I. S. J. Mater. Process. Technol. 2005, 167, 283-293.
Vaisman, L.; Wachtel, E.; Wagner, H. D.; Marom, G. Polymer 2007, 48, 6843-6854.
Owens, C. N. Investigation into Polymer and Carbon Nanomaterial Separations. Ph.D. Dissertation, The Ohio State University, Columbus, Ohio, August 2012.
Fetzer, J. C. Polycyclic Aromatic Compd. 2000, 27, 143-162.
Loncar, E. S.; Kolarov, L. A.; Malbasa, R. V.; Skrbic, B. D. J. Serb. Chem. Soc. 2005, 70, 1237-1242.
Daisey, J. M.; Leyko, M. A. Anal. Chem. 1979, 51, 24-26.
Dong, M.; Locke, D. C. Anal. Chem. 1976, 48, 368-372.
Kraft, J.; Hartung, A.; Lies, K.-H.; Schulze, J. J. High. Resolut. Chromatogr. 1982, 5, 489-494.
Geiss, F. Fundamentals of Thin Layer Chromatography; Huethig: Heidelberg, Germany, Basel, Switzerland, New York, U.S.A., 1987.
Poole, C. F.; Poole, S. K. J. Chromatogr. A 1995, 703, 573-612.

1. An ultrathin-layer chromatography plate comprising a stationary phase including electrospun composite nanofibers comprising a polymer and at least one of multi-walled carbon nanotubes, edge-plane ordered carbon nanorods and amorphous carbon nanorods, wherein the stationary phase has a thickness between about 5 μm and about 30 μm.

2. The ultrathin-layer chromatography plate of claim 1, wherein the composite nanofibers comprise between 0% and about 2% by weight of multi-walled carbon nanotubes.

3. The ultrathin-layer chromatography plate of claim 2, wherein the surface of the multi-walled carbon nanotubes include carboxylic acid functional groups.

4. The ultrathin-layer chromatography plate of claim 2, wherein the composite nanofibers have an average diameter between about 250 nm and about 450 nm.

5. The ultrathin-layer chromatography plate of claim 1, wherein the composite nanofibers comprise between 0% and about 1% edge-plane ordered carbon nanorods.

6. The ultrathin-layer chromatography plate of claim 1, wherein the composite nanofibers comprise between 0% and about 1% amorphous carbon nanorods.

7. The ultrathin-layer chromatography plate of claim 5, wherein the composite nanofibers have an average diameter between about 300 nm and about 600 nm.

8. The ultrathin-layer chromatography plate of claim 1, wherein the polymer is selected from a polyacrylonitrile, an epoxide polymer, a polycaprolactone, a polystyrene, a polyvinyl alcohol, a poly(methyl methacrylate), a polyhydroxyalkanoate, and a polyethylene.

9. The ultrathin-layer chromatography plate of claim 8, wherein the polymer is a polyacrylonitrile.

10. The ultrathin-layer chromatography plate of claim 1, wherein the stationary phase has a length and a width, and the thickness of the stationary phase is substantially consistent along its entire length and width.

11. A method of making an ultrathin-layer chromatography plate having a stationary phase comprising composite nanofibers comprising a polymer and at least one of multi-walled carbon nanotubes, edge-plane ordered carbon nanorods and amorphous carbon nanorods, the method comprising:
electrospinning a solution comprising the polymer and at least one of multi-walled carbon nanotubes, edge-plane ordered carbon nanorods and amorphous carbon nanorods to form a mat comprising the composite nanofibers.

12. The method of claim 11, wherein the composite nanofibers comprise between 0% and about 2% by weight of multi-walled carbon nanotubes.

13. The method of claim 12, wherein the multi-walled nanotubes have been oxidized in acid so that the surface of the multi-walled carbon nanotubes includes carboxylic acid functional groups.

14. The method of claim 12, wherein the composite nanofibers have an average diameter between about 250 nm and about 450 nm.

15. The method of claim 11, wherein the composite nanofibers comprise between 0% and about 1% edge-plane ordered carbon nanorods.

16. The method of claim 11, wherein the composite nanofibers comprise between 0% and about 1% amorphous carbon nanorods.

17. The method of claim 15, wherein the composite nanofibers have an average diameter between about 300 nm and about 600 nm.

18. The method of claim 11, wherein the polymer is selected from a polyacrylonitrile, an epoxide polymer, a polycaprolactone, a polystyrene, a polyvinyl alcohol, a poly(methyl methacrylate), a polyhydroxyalkanoate, and a polyethylene.

19. The ultrathin-layer chromatography plate of claim 18, wherein the polymer is a polyacrylonitrile.

20. The method of claim 11, wherein the solution comprises DMF.
